(19) United States
(12) Patent Application Publication
(10) Pub. No.: US 2005/0134938 A1
(43) Pub. Date: Jun. 23, 2005

(54) Systems and methods for tracking communication

(76) Inventors: Brad S. Perry, North Salt Lake, UT (US); Robert T. Smith, Salt Lake City, UT (US)

Correspondence Address: Kirton & McConkie, 1800 Eagle Gate Tower, 60 East South Temple, Salt Lake City, UT, 84111, US

(21) Appl. No.: 10/744,576

(22) Filed: Dec. 22, 2003

(51) Int. Cl. H04N 1/40; G06F 15/16

(52) U.S. Cl. 358/462; 709/206

(57) ABSTRACT

Systems and methods for tracking communication. More particularly, a method and system for tracking related communication in an efficient and effective manner that identifies a communication, converts the communication into a searchable form, establishes text-based search parameters, identifies metadata to be used in identifying related communications, uses both metadata and text-based search parameters to track related communications, weights the search results and provides a user an opportunity to modify the search parameters to produce improved search results.

### BACKGROUND OF THE INVENTION

1. Field of the Invention

The present invention relates to tracking communication. More particularly, the present invention relates to a method and system for tracking related communication in an efficient and effective manner.

2. Background and Related Art

Written communication plays an important role in business. In fact, with the advent of electronic communication and more particularly email, more people today communicate in written form than ever before. When the need to track the path or thread of a series of communications dealing with the same topic arises, however, important information is often found in a variety of communication forms, such as electronic communication, traditional written communication and digital communication, complicating communication tracking. Because today's written communication often takes the place of face-to-face or telephone conversations, there is also often a large amount of communications to search. Accessing such communication threads can be very helpful because it provides a much more detailed and documented trail of communication. However, accessing all communication forms can often be problematic because these forms are not easily searchable. For example, although electronic communication is usually in written form, paper copies often do not exist. Also, because of the large volume of electronic communication that takes place, tracking relevant electronic communication can become cumbersome. In addition, because some electronic communications are sent to a large number of people, the related return communications are often difficult to track. An especially difficult obstacle occurs when a thread is broken and a new thread is created or when an electronic communication leads to another form of communication such as a letter or a voice mail. Sometimes a new electronic tread is created when a sender does not wish the recipient to see the dates and prior recipients in a thread.

### SUMMARY OF THE INVENTION

The present invention relates to tracking communication. More particularly, the present invention relates to a method and system for tracking related communication in an efficient and effective manner.

Implementation of the present invention takes place in association with a group of potentially related communications. These communications can be in many forms, including written, electronic or digital. In one implementation, metadata is used to track related communications, identifying and organizing such communication. In a related implementation, the related communications are organized into a graphical representation, such as a family tree-type chart, allowing easy interpretation of the relatedness of each communication. This implementation is effective at tracking related electronic communications that have been generated by replying to a relevant, originating electronic communication. This implementation is also effective at tracking related email communications that are sent to others as carbon copies or even as blind carbon copies.

In another implementation, a text-based search is performed using information gathered from the above-mentioned communication tracking to construct an evaluation algorithm, focusing on finding relevant communications. This text-based search can include key word, concept-based and fuzzy-logic searches. In a related implementation, a search is performed based on relevant dates or people, also focusing on finding relevant electronic communications. In another related implementation, human intervention is required to review search results in order to ensure the inclusion of all relevant electronic communication in a search report.

In yet another implementation, both metadata and text-based searches are performed. In a related implementation, the search results are weighted based on their potential relevance.

In even another implementation, a user reviews an initial list of search results and makes a determination as to whether the list is appropriate. If the list is appropriate, the user then precedes to a more detailed review of the search results. If the list is inappropriate, the user then modifies one or more of the search processes in order to generate better search results. The scope of the search results may be too broad if many irrelevant search results are returned and may be too narrow if all search results that are returned are relevant.

Disclosed in more detail herein are two broad embodiments of the invention. In the first of these embodiments, software primarily determines the search parameters and in the second, a user manually determines the search parameters.

While the methods and processes of the present invention have proven to be particularly useful in the area of tracking a group of related communications, those skilled in the art can appreciate that the methods and processes can be used in a variety of different applications and in a variety of different areas of manufacture to yield efficient and effective communication tracking.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific implementations thereof, which are illustrated in the appended drawings. Understanding that the drawings depict only typical implementations of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1;

FIG. 3 illustrates a flow chart that provides a representative implementation of the communication tracking system and method that converts non-electronic documents into electronic documents;

FIG. 4 illustrates a flow chart that provides another representative implementation of the communication tracking system and method with more manual input;

FIG. 5 illustrates a flow chart that provides a representative implementation of the communication tracking system and method that converts documents into a searchable form; and

FIG. 6 illustrates a flow chart that provides another representative implementation of the communication tracking system and method that converts documents into a searchable form with more manual input.

### DETAILED DESCRIPTION OF THE INVENTION

The present invention relates to tracking communication. More particularly, the present invention relates to a method and system for tracking related communication in an efficient and effective manner.

In the disclosure and in the claims the term “communication” shall refer to any communication that would benefit from a system and method such as herein disclosed, such as email, instant-messaging, phone-call data, letters, wav files and all other searchable forms of communication.

The term “metadata” shall refer to all relevant information including the text of the communication, including hidden data, the identities and addresses (including email and street addresses) of the senders and recipients, the date and time of the communication and all other information related to the communication that would be helpful in constructing a search for related communications.

The following disclosure of the present invention is grouped into 2 subheadings, namely “Exemplary Operating Environment” and “System and Method for Tracking Communication.” The utilization of the subheadings is for convenience of the reader only and is not to be construed as limiting in any sense.

### Exemplary Operating Environment

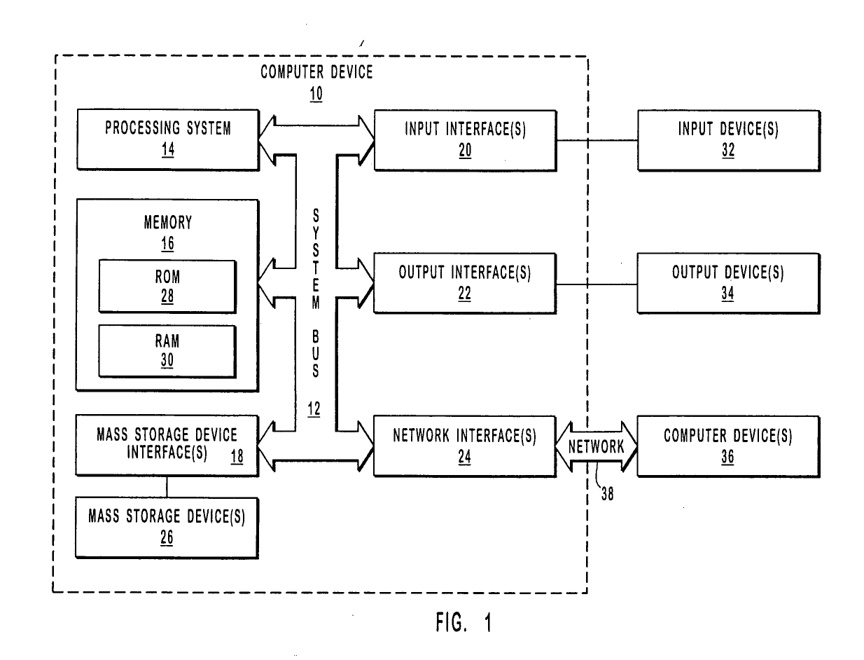

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Implementations of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a global computer or wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

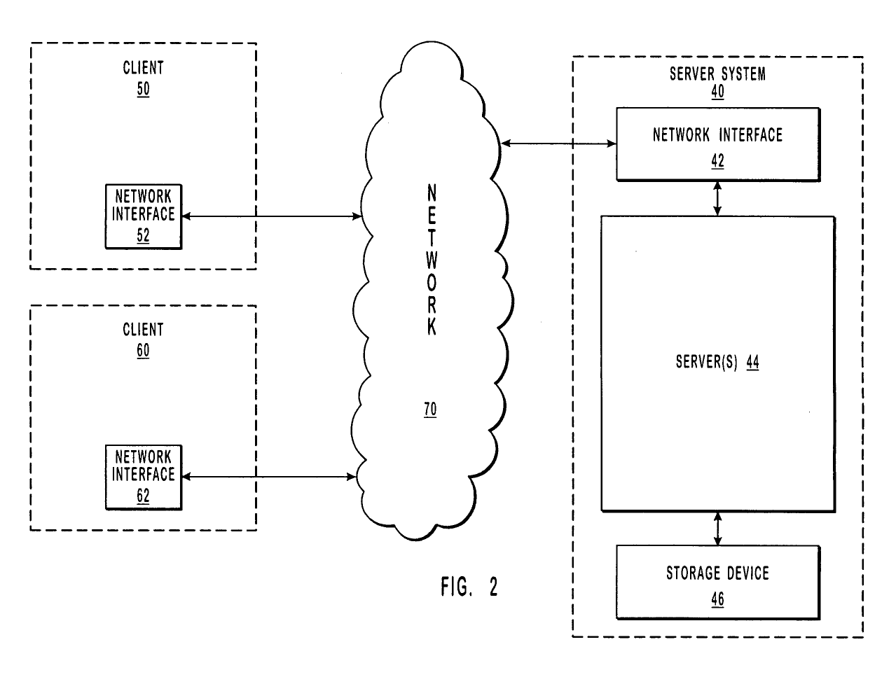

While those skilled in the art will appreciate that the invention may be practiced in networked computing environments with many types of computer system configurations, FIG. 2 represents an implementation of the present invention in a networked environment that includes clients connected to a server via a network. While FIG. 2 illustrates an implementation that includes two clients connected to the network, alternative implementations include one client connected to a network or many clients connected to a network. Moreover, implementations in accordance with the present invention also include a multitude of clients throughout the world connected to a network, where the network is a global computer or wide area network, such as the Internet.

In FIG. 2, a representative networked configuration is provided in which systems and methods for managing processes operate. Server system 40 represents a system configuration that includes one or more servers. Server system 40 includes a network interface 42, one or more servers 44, and a storage device 46. A plurality of clients, illustrated as clients 50 and 60, communicate with server system 40 via network 70, which may include a wireless network, a local area network, and/or a wide area network. Network interfaces 52 and 62 are communication mechanisms that respectfully allow clients 50 and 60 to communicate with server system 40 via network 70. For example, network interfaces 52 and 62 may be a web browser or other network interface. A browser allows for a uniform resource locator (“URL”) or an electronic link to be used to access a web page sponsored by a server 44. Therefore, clients 50 and 60 may independently access or exchange information with server system 40.

As provided above, server system 40 includes network interface 42, servers 44, and storage device 46. Network interface 42 is a communication mechanism that allows server system 40 to communicate with one or more clients via network 70. Servers 44 include one or more servers for processing and/or preserving information. Storage device 46 includes one or more storage devices for preserving information, such as electronic documents having images. Storage device 46 may be internal or external to servers 44.

### System and Method for Tracking Communication

The purpose of the system and method for tracking communication is to find communications addressing an identified topic of interest. There are several methods of doing this, which are addressed below.

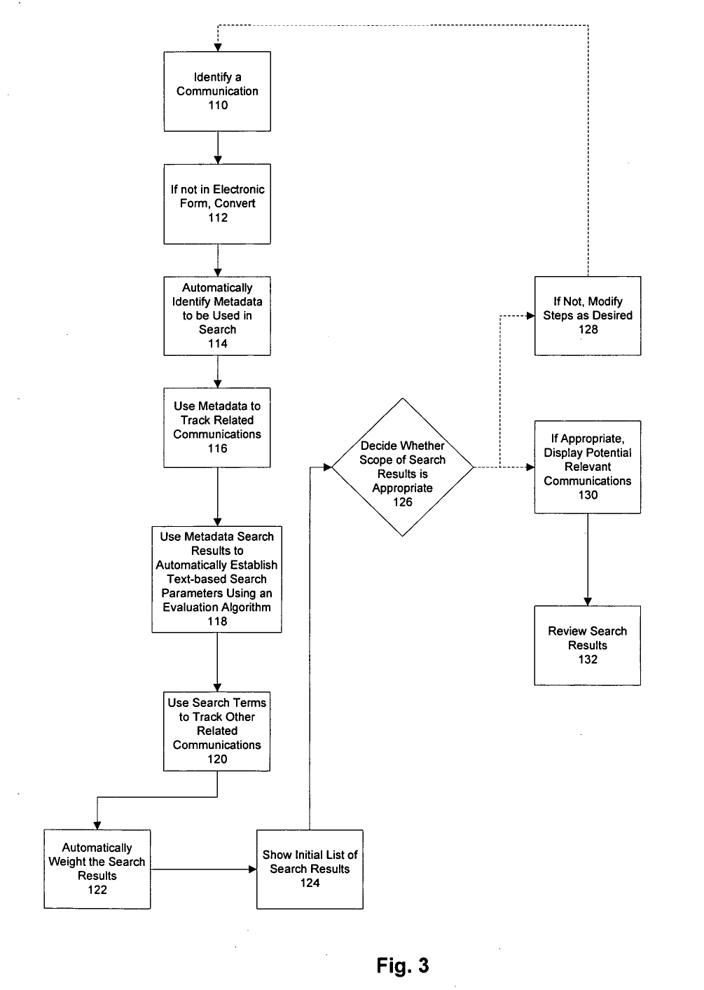

FIG. 3 illustrates a flow chart that provides a representative implementation of the communication tracking system and method. In FIG. 3, execution begins at step 110 where a communication is identified. At step 112, if the communication is not in an electronic form, it is converted into an electronic form. This conversion can take place in many ways, including scanning or transcribing a written communication. At step 114, the communication's metadata are automatically identified. The metadata will later be used to track other related communications. For example, in an email, metadata includes the author, recipients (including cc's and blind cc's), date and time of the email, whether the email was opened or deleted, and other relevant information about the email.

At step 116, the metadata is used to track related communications. For example, metadata is used to track the communication thread of the communication identified in step 110; tracking the communication flow between an email sender and its recipients, including “replied to” messages. This type of communication tracking is helpful in constructing electronic paper trails of communication related to an originating electronic communication. It is also helpful to successfully track related communications that are not electronic, such as letters or notes. The results of these communication threads are often presented in a graphical relationship. In some embodiments, this graphical relationship is a family tree-type format.

At step 118, text-based evaluation parameters using an evaluation algorithm are automatically established. The metadata search results from step 116 are automatically considered in this step. These search parameters can include key-word, concept-based or fuzzy-logic searches, or the search parameters can include specific data parameters such as specific dates or specific authors or recipients identified in an email thread. The algorithm can find any terms common in an email thread and can eliminate irrelevant words. A typical search will focus on nouns and verbs and will ignore articles. Step 120 consists of using the automatically created text-based search parameters to track other related communications. During this step, the emails in a group are compared against the search criteria, in order to find potentially relevant emails. Step 122 automatically weights these search results. For example, a high priority will be given to a name of an author of an email thread that is identified or to a communication containing all of the search terms. On the other hand, a low priority will be given to a search result that contains only half of the search terms.

At step 124, an initial list of search results is produced. The user reviews this list and at step 126, decides whether the scope of the search results is appropriate. The scope of the search results may be too broad if many irrelevant search results are returned and may be too narrow if all search results that are returned are relevant. If the user decides the scope of the search is not appropriate, the user then, as shown in step 128, proceeds again to the first step 110, modifying steps as desired. Here for example, a user may decide that the communication identified in step 110 is not relevant, or that the text-based search parameters established in step 118 need modifying. On the other hand, if the user decides the scope of the search is appropriate, as shown in step 130, the user proceeds to step 132 and reviews the search results.

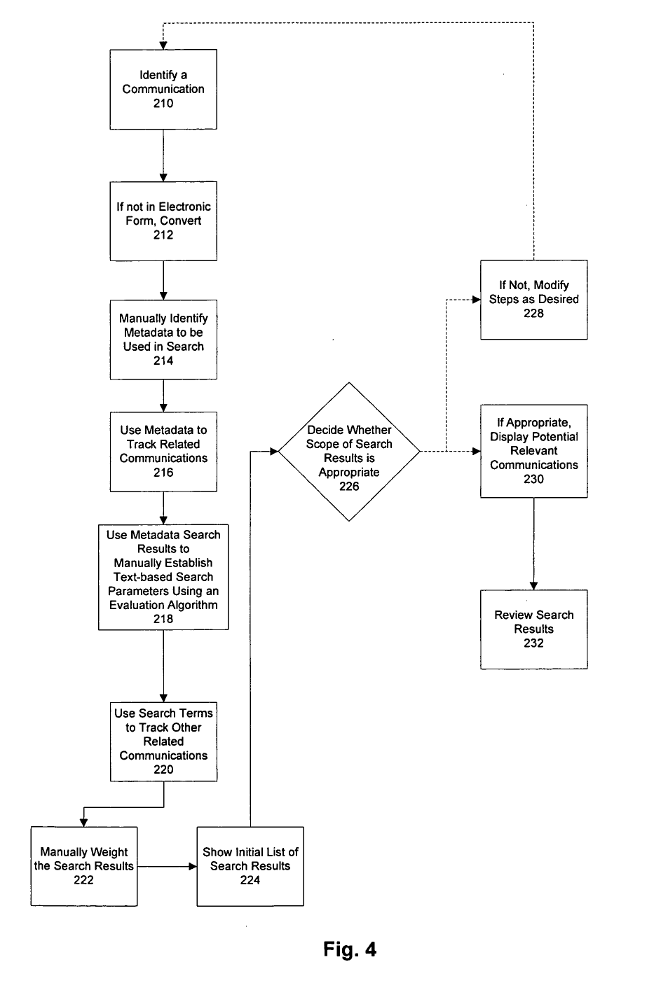

FIG. 4 shows a process similar to the process of FIG. 3, but provides for more manual input from the user. For instance, the user can manually establish text-based search parameters, as shown in step 218, as well as manually identifying the metadata to be used in the search, as shown in step 214. The entire process can be manually inputted if desired, or the process can proceed using any combination of manual or automatic implementation.

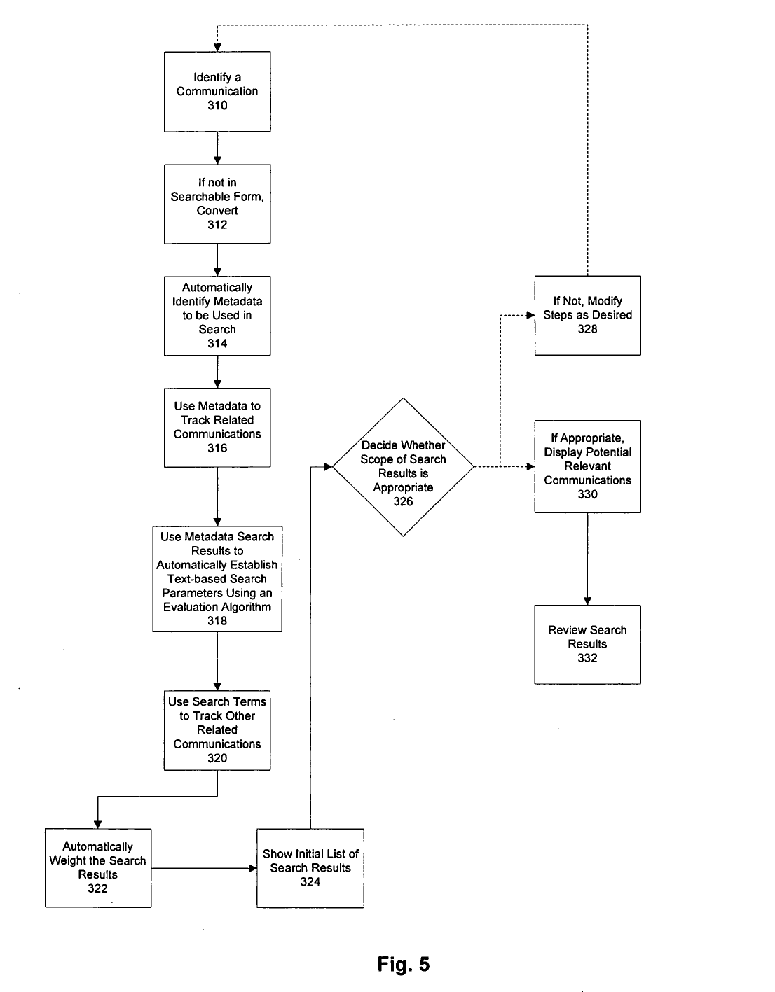

FIG. 5 shows a process similar to the process of FIG. 3, but provides for conversion of communications into any searchable form, including digital forms such as wav files.

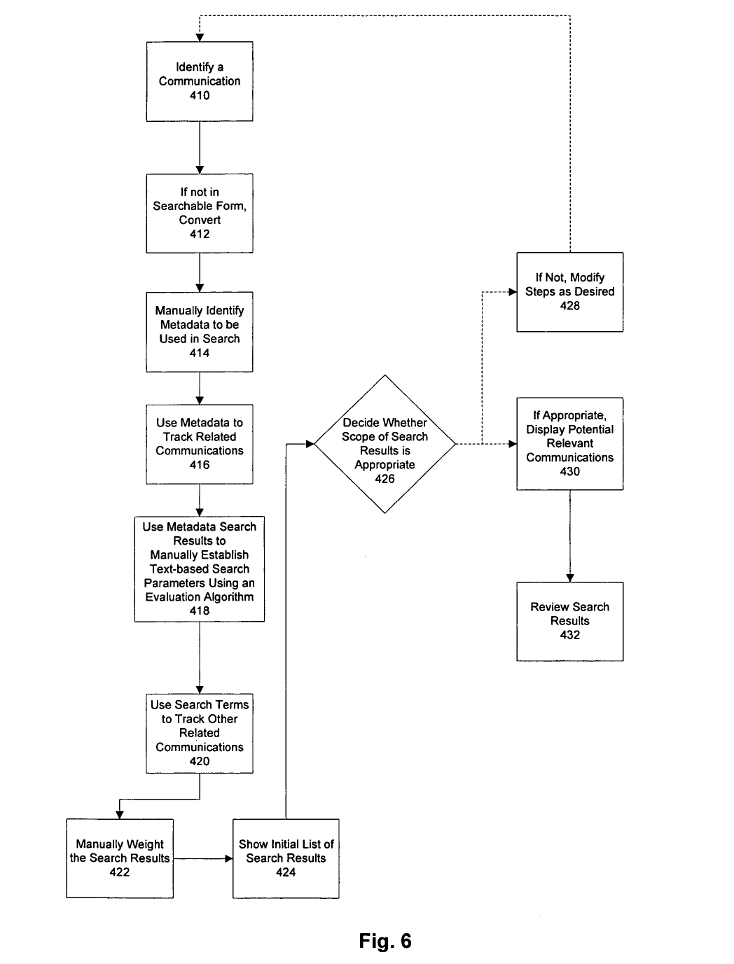

FIG. 6 shows a process similar to the process of FIG. 5, but provides for more manual input from the user. For instance, the user can manually establish text-based search parameters, as shown in step 418, as well as manually identifying the metadata to be used in the search, as shown in step 414. The entire process can be manually inputted if desired, or the process can proceed using any combination of manual or automatic implementation.

Thus, as discussed herein, the implementations of the present invention embrace a method and system for tracking related communications.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for identifying related communications comprising the steps of:
providing a computer readable medium;
identifying a communication;
converting said communication into an electronic form, if said communication is in a non-electronic form;
identifying a group of metadata of said communication;
using said group of metadata to identify a first related communication;
using said group of metadata and said first related communication to establish a text-based search parameter that uses an evaluation algorithm;
using said text-based search parameter to identify a second related communication;
weighting the relevance of said second related communication;
reviewing an initial list of said first related communication and said second related communication;
deciding whether said initial list is appropriate; and
performing at least one of the following:
reviewing said first related communication and said second related communication, if said initial list is determined to be appropriate; or
modifying at least one step of said method for identifying related communications, if said initial list is determined to be inappropriate.

2. The method of claim 1, wherein said text-based search parameter includes a relevant date.

3. The method of claim 1, wherein said text-based search parameter includes information about a sender.

4. The method of claim 1, wherein said text-based search parameter includes information about a recipient.

5. The method of claim 1, wherein said group of metadata is automatically identified.

6. The method of claim 1, wherein said group of metadata is manually identified.

7. The method of claim 1, wherein said text-based search parameter is automatically established.

8. The method of claim 1, wherein said text-based search parameter is manually established.

9. The method of claim 1, wherein the relevance of said second related communication is automatically weighted.

10. The method of claim 1, wherein the relevance of said second related communication is manually weighted.

11. The method of claim 1, wherein said electronic form is a searchable form and said non-electronic form is an unsearchable form.

12. The method of claim 1, wherein said electronic form is a digital form and said non-electronic form is a non-digital form.

13. The method of claim 1, wherein said electronic form is a wav file and said non-electronic form is a non-wav file.

14. The method of claim 1, wherein said text-based search includes key word, concept-based and fuzzy-logic searches.

15. A computer program product for implementing within a computer system a method for identifying related communications comprising:
a computer readable medium for providing computer program code means utilized to implement the method, wherein the computer program code means is comprised of executable code for implementing the steps of:
identifying a communication;
converting said communication into an electronic form, if said communication is in a non-electronic form;
identifying a group of metadata of said communication;
using said group of metadata to identify a first related communication;
using said group of metadata and said first related communication to establish a text-based search parameter that uses an evaluation algorithm;
using said text-based search parameter to identify a second related communication;
weighting the relevance of said second related communication;
reviewing an initial list of said first related communication and said second related communication;
deciding whether said initial list is appropriate; and
performing at least one of the following:
reviewing said first related communication and said second related communication, if said initial list is determined to be appropriate; or
modifying at least one step of said method for identifying related communications, if said initial list is determined to be inappropriate.

16. A system containing a computer program product, the product comprising:
a computer readable medium for providing computer program code means utilized to implement the method, wherein the computer program code means is comprised of executable code for implementing the steps of:
identifying a communication;
converting said communication into an electronic form, if said communication is in a non-electronic form;
identifying a group of metadata of said communication;
using said group of metadata to identify a first related communication;
using said group of metadata and said first related communication to establish a text-based search parameter that uses an evaluation algorithm;
using said text-based search parameter to identify a second related communication;
weighting the relevance of said second related communication;
reviewing an initial list of said first related communication and said second related communication;
deciding whether said initial list is appropriate; and
performing at least one of the following:
reviewing said first related communication and said second related communication, if said initial list is determined to be appropriate; or
modifying at least one step of said method for identifying related communications, if said initial list is determined to be inappropriate.

17. A method for identifying related communications comprising the steps of:
providing a computer readable medium;
identifying a communication;
converting said communication into a searchable form, if said communication is in an unsearchable form;
identifying a group of metadata of said communication;
using said group of metadata to identify a first related communication;
using said group of metadata and said first related communication to establish a text-based search parameter that uses an evaluation algorithm;
using said text-based search parameter to identify a second related communication;
weighting the relevance of said second related communication;
reviewing an initial list of said first related communication and said second related communication;
deciding whether said initial list is appropriate; and
performing at least one of the following:
reviewing said first related communication and said second related communication, if said initial list is determined to be appropriate; or
modifying at least one step of said method for identifying related communications, if said initial list is determined to be inappropriate.

18. The method of claim 17, wherein said searchable form is a digital form and said unsearchable form is a non-digital form.

19. The method of claim 17, wherein said searchable form is a wav file and said unsearchable form is a non-wav file.

20. A method for identifying related emails comprising the steps of:
providing a computer readable medium;
automatically identifying an email of interest;
automatically constructing at least one of the following types of searches based on said email of interest in order to find other emails related to said email of interest:
key word based searches;
concept-based searches; or
fuzzy-logic searches; and
automatically presenting a list of said other emails related to said email of interest, including the relationships between said emails of interest.
